(19) United States
(12) Patent Application Publication
(10) Pub. No.: US 2026/0298299 A1
(43) Pub. Date: Oct. 1, 2026

(54) CALIPER-TYPE ELECTROSTATIC PRECIPITATOR AND VEHICLE BRAKING DEVICE INCLUDING SAME

(71) Applicant: KOREA INSTITUTE OF MACHINERY & MATERIALS, Daejeon (KR)

(72) Inventors: Gunhee LEE, Daejeon (KR); Bangwoo HAN, Daejeon (KR); Dongho SHIN, Daejeon (KR); Chae Yeon JO, Daejeon (KR); Inyong PARK, Daejeon (KR); Daehoon PARK, Paju-si (KR); Keejung HONG, Seoul (KR)

(21) Appl. No.: 19/166,974

(22) PCT Filed: Dec. 3, 2024
(86) PCT No.: PCT/KR2024/019620

§ 371 Date: Sep. 19, 2025

(30) Foreign Application Priority Data
Dec. 22, 2023 (KR) 10-2023-0189934

(51) Int. Cl. F16D 65/00; B03C 3/017; B03C 3/47; F16D 55/226

(52) U.S. Cl. CPC F16D 65/0031; B03C 3/017; B03C 3/47; F16D 55/226; B03C 2201/30

(57) ABSTRACT

According to an embodiment of the present disclosure, provided is a caliper-type electrostatic precipitator including a caliper portion applying braking force to a brake disc, a dust collection portion which is spaced apart from the caliper portion and electrostatically precipitates particles generated by friction between the brake disc and the caliper portion, and a guide portion which is configured to cover a space between the caliper portion and the dust collection portion and provides a movement path of the particles.

### TECHNICAL FIELD

The present disclosure relates to a caliper-type electrostatic precipitator and a vehicle braking device including the same.

### BACKGROUND ART

It is generally known that fine dust generated during automobile driving is generated in large quantities by wear of tires and brake pads in addition to exhaust gases. In order to reduce fine dust in cities, it is necessary to reduce fine dust generated by automobiles, which are one of the main sources of mobile pollution.

Specifically, the braking system of a vehicle generates braking force through frictional force generated by pressing brake pads against a brake disc that rotates along with the vehicle's wheels, and when the vehicle is braking, various types of dust harmful to the human body are generated due to wear of the brake pads caused by friction between the brake disc and brake pads.

It is known that, as the size of fine dust generated by brake pad wear is very small and the components are harmful, fine dust has a harmful effect on the human body, causing respiratory diseases, eye diseases, and skin diseases. Therefore, development of technology to address this problem is required.

Due to the recent increase in hydrogen and electric vehicles, the impact of fine dust generated by exhaust gas is expected to gradually decrease. However, since hydrogen and electric vehicles use the same braking method as internal combustion vehicles, fine dust generated by tire and brake pad wear still occurs.

Previously, devices were developed to capture fine dust generated by tire and brake pad wear by installing the same around the wheels of the vehicle, and most of these devices use a filter method.

However, in the case of filter-type air purifiers, it is difficult to allow inflow of the air containing particles due to pressure loss through the filter, and thus it is difficult to actually capture fine dust after a certain period of time. In addition, fiber filters have limitations in terms of maintenance/repair, such as the difficulty in cleaning and regenerating the filter, which requires frequent replacement.

### DISCLOSURE OF INVENTION

### Technical Problem

The present disclosure provides a caliper-type electrostatic precipitator for efficiently precipitating dust particles from a brake disc and a pad, by including a guide portion movably arranged on the brake disc, and a vehicle braking device including the same.

The objectives to be achieved by the present disclosure are not limited to the objectives mentioned above, and other objectives and advantages of the present disclosure that are not mentioned may be understood by the following description and will be more clearly understood by the embodiments of the present disclosure. In addition, it will be appreciated that the objectives and advantages to be achieved by the present disclosure may be realized by the means and combinations thereof indicated in the patent claims.

### Solution to Problem

A caliper-type electrostatic precipitator according to an aspect of the present disclosure may include: a caliper portion applying braking force to a brake disc; a dust collection portion which is spaced apart from the caliper portion and electrostatically precipitates particles generated by friction between the brake disc and the caliper portion; and a guide portion which is configured to cover a space between the caliper portion and the dust collection portion and provides a movement path of the particles.

A caliper-type electrostatic precipitator according to another aspect of the present disclosure may include: a caliper portion applying braking force to a brake disc; and a dust collection portion which is spaced apart from the caliper portion and electrostatically precipitates particles generated by friction between the brake disc and the caliper portion, wherein the dust collection portion comprises: a first dust-collection plate to which a high voltage is applied; a second dust-collection plate that is spaced apart from the first dust-collection plate and is grounded; and a cover portion that accommodates the first dust-collection plate and the second dust-collection plate thereinside and is movable in a circumferential direction of the brake disc.

A vehicle braking device according to an aspect of the present disclosure may include: a wheel of a vehicle; a brake disc that rotates integrally with the wheel of the vehicle; a caliper portion having a brake pad that applies braking force to the brake disc; a dust collection portion disposed on the brake disc, spaced apart from the caliper portion, and electrostatically precipitating particles generated from the brake pad; and a guide portion configured to move on the brake disc from an area where the caliper portion is located to an area where the dust collection portion is located.

### Advantageous Effects of Invention

According to embodiments of the present disclosure, according to a caliper-type electrostatic precipitator and a vehicle braking device including the same, a guide portion guides a movement path of dust particles from a caliper portion to a dust collection portion, thereby improving the precipitation performance for dust particles.

However, the effects that may be obtained through the present disclosure are not limited to the effects described above, and other technical effects not mentioned will be clearly understood by those skilled in the art from the description of the present disclosure described below.

### BRIEF DESCRIPTION OF DRAWINGS

The following drawings attached to the present specification illustrate preferred embodiments of the present disclosure and, together with the detailed description of the present disclosure described below, serve to further understand the technical idea of the present disclosure; therefore, the present disclosure should not be interpreted as being limited to matters described in such drawings.

FIG. 1 is a schematic diagram of a caliper-type electrostatic precipitator according to an embodiment of the present disclosure.

FIG. 2 is a diagram illustrating a state of use of a caliper-type electrostatic precipitator according to an embodiment of the present disclosure.

FIG. 3 is a diagram illustrating a state in which a guide portion according to an embodiment of the present disclosure is arranged at a first position.

FIG. 4 is a diagram illustrating a state in which a guide portion according to an embodiment of the present disclosure is arranged at a second position.

FIG. 5 is a diagram illustrating a dust collection portion according to an embodiment of the present disclosure.

FIG. 6 is a block diagram for describing a control portion according to an embodiment of the present disclosure.

FIG. 7 is a schematic diagram of a caliper-type electrostatic precipitator according to another embodiment of the present disclosure.

FIG. 8 is a diagram illustrating a state of use of a caliper-type electrostatic precipitator according to another embodiment of the present disclosure.

### BEST MODE FOR CARRYING OUT THE INVENTION

A caliper-type electrostatic precipitator according to one aspect of the present disclosure may include: a caliper portion that applies braking force to a brake disc; a dust collection portion that is spaced apart from the caliper portion and electrostatically precipitate particles generated by friction between the brake disc and the caliper portion; and a guide portion that may cover a space between the caliper portion and the dust collection portion and provides a movement path for the particles.

In the present embodiment, the guide portion may be movable in a circumferential direction of the brake disc.

In the present embodiment, the caliper-type electrostatic precipitator may further include a control portion controlling a position of the guide portion in the circumferential direction of the brake disc.

In the present embodiment, the control portion may be configured to adjust a position of the guide portion according to a rotation speed of the brake disc.

In the present embodiment, the guide portion may be configured to selectively accommodate the caliper portion.

In the present embodiment, the dust collection portion may include: a first dust-collection plate to which a high voltage is applied; a second dust-collection plate that is spaced apart from the first dust-collection plate and is grounded; and a cover portion that accommodates the first dust-collection plate and the second dust-collection plate thereinside and extends in the circumferential direction of the brake disc, wherein the guide portion is movably connected to one side of the cover portion.

In the present embodiment, the guide portion may be arranged to surround one end of the cover portion, the one end facing the caliper portion.

A caliper-type electrostatic precipitator according to another aspect of the present disclosure may include: a caliper portion applying braking force to a brake disc; and a dust collection portion which is spaced apart from the caliper portion and electrostatically precipitates particles generated by friction between the brake disc and the caliper portion, wherein the dust collection portion includes: a first dust-collection plate to which a high voltage is applied; a second dust-collection plate that is spaced apart from the first dust-collection plate and is grounded; and a cover portion that accommodates the first dust-collection plate and the second dust-collection plate thereinside and is movable in a circumferential direction of the brake disc.

In the present embodiment, the cover portion may be configured to selectively cover the caliper portion while moving toward the caliper portion.

In the present embodiment, the caliper-type electrostatic precipitator may further include a driving portion that receives power from the outside and provides driving force to the cover portion.

A vehicle braking device according to an aspect of the present disclosure may include: a wheel of a vehicle; a brake disc that rotates integrally with the wheel of the vehicle; a caliper portion having a brake pad that applies braking force to the brake disc; a dust collection portion disposed on the brake disc, spaced apart from the caliper portion, and electrostatically precipitating particles generated from the brake pad; and a guide portion configured to move on the brake disc from an area where the caliper portion is located to an area where the dust collection portion is located.

In the present embodiment, the guide portion may be movable in a circumferential direction of the brake disc.

In the present embodiment, the vehicle braking device may further include a control portion controlling a position of the guide portion in the circumferential direction of the brake disc.

In the present embodiment, the control portion may be configured to adjust a position of the guide portion according to a rotation speed of the brake disc.

In the present embodiment, the dust collection portion may include: a first dust-collection plate to which a high voltage is applied; a second dust-collection plate that is spaced apart from the first dust-collection plate and is grounded; and a cover portion that accommodates the first dust-collection plate and the second dust-collection plate thereinside and extends in the circumferential direction of the brake disc, wherein the guide portion is movably connected to one side of the cover portion.

In the present embodiment, the guide portion may be arranged to surround one end of the cover portion, the one end facing the caliper portion.

Other aspects, features and advantages other than those described above will become apparent from the following drawings, claims and detailed description of the present disclosure.

### Mode for the Invention

As the present disclosure allows for various changes and numerous embodiments, particular embodiments will be illustrated in the drawings and described in detail in the written description. The effects and features of the present disclosure, and ways to achieve the same will become apparent by referring to embodiments that will be described later in detail with reference to the drawings. However, the present disclosure is not limited to the following embodiments but may be embodied in various forms.

Hereinafter, embodiments of the present disclosure will be described in detail with reference to the accompanying drawings, and in the description with reference to the drawings, like reference numerals refer to like elements and redundant descriptions thereof will be omitted.

Singular expressions, unless defined otherwise in contexts, include plural expressions.

In the embodiments below, it will be further understood that the terms “comprise” and/or “have” used herein specify the presence of stated features or elements, but do not preclude the presence or addition of one or more other features or elements.

When an embodiment is implementable in another manner, a predetermined process order may be different from a described one. For example, two processes that are consecutively described may be substantially simultaneously performed or may be performed in an opposite order to the described order.

Also, in the drawings, for convenience of description, sizes of elements may be exaggerated or contracted. For example, since sizes and thicknesses of elements in the drawings are arbitrarily illustrated for convenience of explanation, the following embodiments are not limited thereto.

When each constituent element is described as being formed “on” or “under” a constituent element, the constituent element may be formed “directly” or “indirectly” with any other constituent element therebetween “on” or “under” the constituent element. The status of “on” or “under” of a constituent element is described based on the drawings.

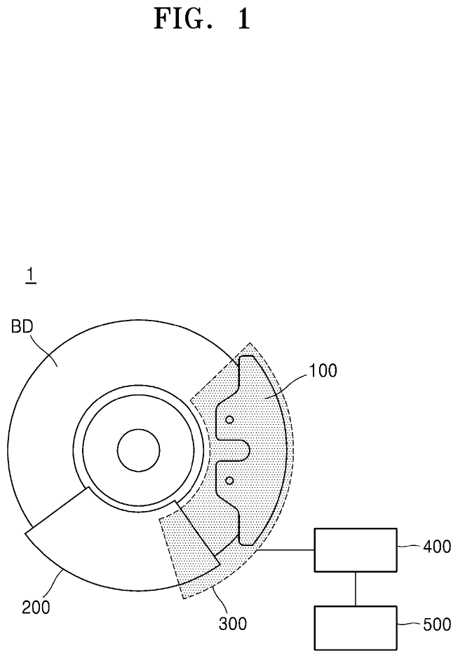

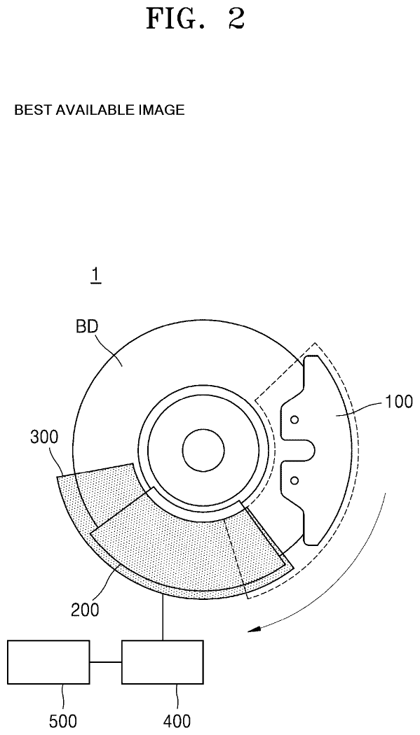

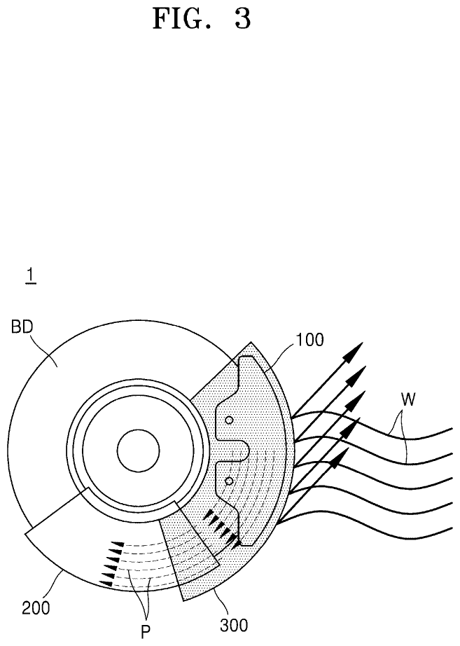

FIG. 1 is a diagram schematically illustrating a caliper-type electrostatic precipitator according to an embodiment of the present disclosure, FIG. 2 is a diagram illustrating a state of use of a caliper-type electrostatic precipitator according to an embodiment of the present disclosure, and FIG. 3 is a diagram illustrating a state in which a guide portion according to an embodiment of the present disclosure is arranged at a first position.

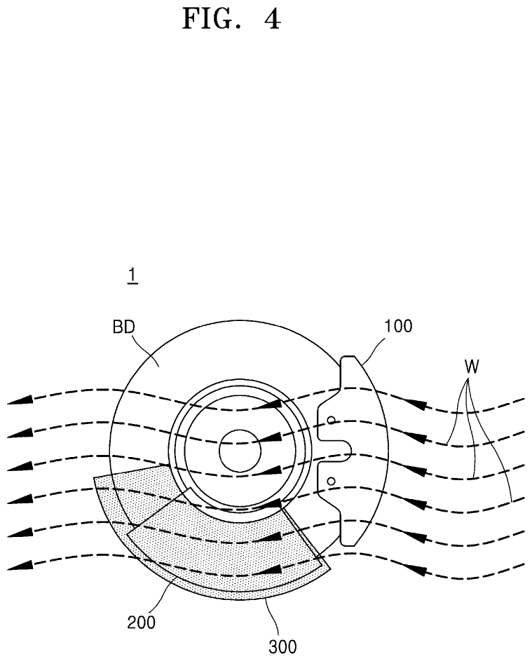

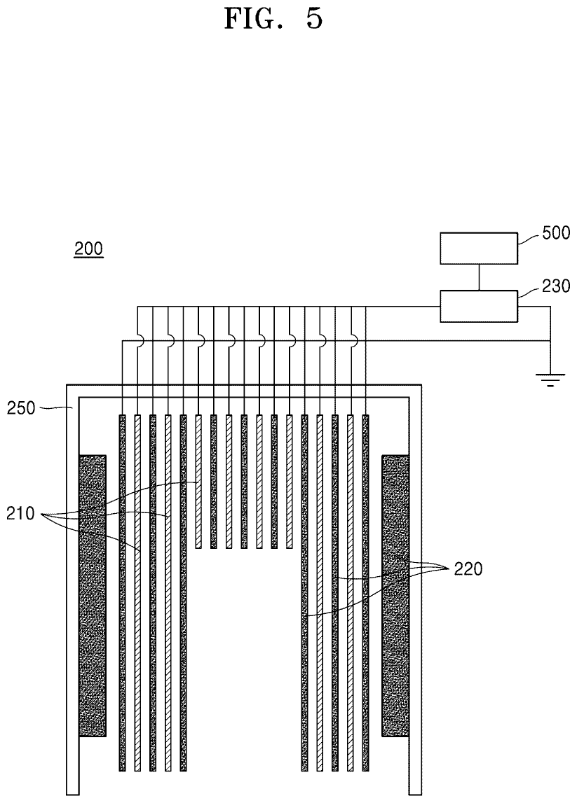

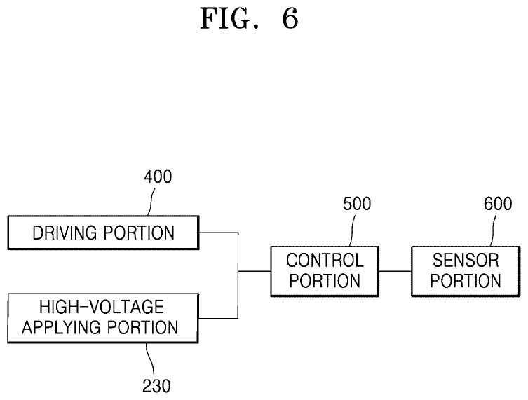

FIG. 4 is a diagram illustrating a state in which a guide portion according to an embodiment of the present disclosure is arranged at a second position, FIG. 5 is a diagram illustrating a dust collection portion according to an embodiment of the present disclosure, and FIG. 6 is a block diagram illustrating a control portion according to an embodiment of the present disclosure.

A caliper-type electrostatic precipitator 1 according to an embodiment of the present disclosure relates to a device that captures, by the force of an electric field, particles P generated by friction between a brake disc BD and a brake pad (not shown) of a caliper portion 100 during braking in a vehicle that performs braking, including the brake disc BD and the caliper portion 100.

Referring to FIGS. 1 to 4, the caliper-type electrostatic precipitator 1 (hereinafter referred to as “electrostatic precipitator 1”) according to an embodiment of the present disclosure may include the brake disc BD, the caliper portion 100, a dust collection portion 200, a guide portion 300, a driving portion 400, and a control portion 500.

The brake disc BD is connected to wheels of a vehicle to rotate in conjunction with the wheels. In detail, when the wheels rotate, the brake disc BD also rotates integrally with the wheels, and when braking force is applied to the brake disc BD, the rotation speed of the wheels operating integrally with the brake disc BD also decreases.

In the present specification, the ‘wheels’ may be interpreted as wheels of a vehicle.

The brake disc BD forms a braking system of a vehicle together with the caliper portion 100. The caliper portion 100 may include a brake pad that moves according to a user's operation, and according to the user's operation, the brake pad may selectively come into contact with the brake disc BD to provide frictional force, thereby applying braking force to the brake disc BD or the wheels.

Referring to FIGS. 1 and 2, the caliper portion 100 according to an embodiment of the present disclosure may be arranged on one side in a circumferential direction of the brake disc BD, and apply braking force to the brake disc BD by bringing the brake pad into close contact with the brake disc BD according to the user's operation.

In an embodiment, the caliper portion 100 may be positioned on the front side of the vehicle, but is not limited thereto.

The brake disc BD and the caliper portion 100 are applied in various structures to vehicle braking devices of the related art, and thus, a detailed description of the internal structure and operating principle of the brake disc BD and the caliper portion 100 is omitted.

Referring to FIGS. 1, 2, and 5, the dust collection portion 200 according to an embodiment of the present disclosure may be configured to electrostatically precipitate the particles P generated by friction between the brake disc BD and the caliper portion 100, and include a first dust-collection plate 210, a second dust-collection plate 220, a high-voltage applying portion 230, and a cover portion 250.

As the particles P generated from the brake pad are already charged by the friction between the brake pad and the brake disc BD, there is no need to provide a separate charging device for electrostatic precipitation, and the dust collection portion 200 may be arranged at the rear of the caliper portion 100 from which the charged particles P are discharged, and thus the particles P may be captured by the force of an electric field.

As the particles P generated from the brake pad are discharged from the caliper portion 100 in a rotation direction of the brake disc BD, the caliper-type electrostatic precipitator 1 may easily capture the particles P by having the dust collection portion 200 arranged on one side of the caliper portion 100 without a separate air flow device such as a fan.

The dust collection portion 200 may be spaced apart from the caliper portion 100, and specifically, the caliper portion 100 and the dust collection portion 200 may be spaced apart from each other in the circumferential direction of the brake disc BD.

As an optional embodiment, a plurality of dust collection portions 200 may be provided, and the plurality of dust collection portions 200 may be arranged adjacent to each of opposite ends of the caliper portion 100.

Referring to FIG. 5, the first dust-collection plate 210 may receive a high voltage from the high-voltage applying portion 230. Additionally, the second dust-collection plate 220 may be spaced apart from the first dust-collection plate 210 and grounded.

The first dust-collection plate 210 and the second dust-collection plate 220 may be spaced apart from and in parallel to each other in a thickness direction of the brake disc BD.

Specifically, a plurality of first dust-collection plates 210 and a plurality of second dust-collection plates 220 may be provided, and the plurality of first dust-collection plates 210 and the plurality of second dust-collection plates 220 may be spaced apart from each other to be alternately arranged in the thickness direction of the brake disc BD.

For example, one second dust-collection plate 220 may be arranged between two first dust-collection plates 210, and one first dust-collection plate 210 may be arranged between two second dust-collection plates 220.

One surface of the first dust-collection plate 210 and one surface of the second dust-collection plate 220 may be parallel to one surface of the brake disc BD, thus securing a wide contact area between the particles P discharged along the one surface of the brake disc BD and the first dust-collection plate 210 or the second dust-collection plate 220. Accordingly, the particles P may be effectively electrostatically precipitated.

The charged particles P generated between the brake disc BD and the caliper portion 100 may move toward the dust collection portion 200 in the rotation direction of the brake disc BD, and the charged particles P may move to a separation space between the first dust-collection plate 210 and the second dust-collection plate 220.

As a high voltage is applied to the first dust-collection plate 210, and the second dust-collection plate 220 is grounded, an electric field may be formed in the separation space due to a potential difference between the first dust-collection plate 210 and the second dust-collection plate 220, and the charged particles P moving to the separation space may be precipitated in the dust collection portion 200 by the electric field.

As an optional embodiment, a separately provided filter may be arranged between the first dust-collection plate 210 and the second dust-collection plate 220, thereby effectively capturing the particles P, along with the precipitation of the particles P by an electric field.

Referring to FIG. 6, the high-voltage applying portion 230 according to an embodiment of the present disclosure may receive an electrical signal from the control portion 500 and adjust the amplitude of a voltage applied to the first dust-collection plate 210.

The control portion 500 may receive information about a speed of the vehicle or a rotation speed of the brake disc BD, and control the amplitude of the voltage provided by the high-voltage applying portion 230 to the first dust-collection plate 210. Specifically, when the speed of the vehicle or the rotation speed of the brake disc BD is high, the amplitude of the voltage provided by the high-voltage applying portion 230 to the first dust-collection plate 210 may be reduced.

When the vehicle speed or the rotation speed of the brake disc BD is low, the amplitude of the voltage provided by the high-voltage applying portion 230 to the first dust-collection plate 210 may be increased.

Accordingly, when the vehicle speed is high, as the charge quantity of the particles P is high due to strong friction between the brake disc BD and the caliper portion 100, even when the high-voltage applying portion 230 applies a relatively weak high voltage to the first dust-collection plate 210 according to a control signal of the control portion 500, the particles P with a high charge quantity may be easily precipitated with only a weak electric field generated in the dust collection portion 200.

In addition, when the vehicle speed is low, even when the charge quantity of the particles P is not high due to relatively low friction between the brake disc BD and the caliper portion 100, the high-voltage applying portion 230 may apply a relatively strong high voltage to the first dust-collection plate 210 according to a control signal of the control portion 500, thereby easily precipitating the particles P of a low charge quantity.

Through this, the amplitude of the voltage applied to the first dust-collection plate 210 may be appropriately adjusted by the high-voltage applying portion 230 according to the charge quantity of the particles P, and thus, the precipitation performance of the dust collection portion 200 may be improved while minimizing power consumption of the dust collection portion 200.

Referring to FIG. 5, the cover portion 250 according to an embodiment of the present disclosure may accommodate the first dust-collection plate 210 and the second dust-collection plate 220 thereinside, and may be formed to extend in the circumferential direction of the brake disc BD.

A length of the cover portion 250 extending in the circumferential direction of the brake disc BD may be formed to be relatively longer than a length of each of the first dust-collection plate 210 and the second dust-collection plate 220 extending in the circumferential direction of the brake disc BD.

Accordingly, when the particles P flow into a space in which the first dust-collection plate 210 and the second dust-collection plate 220 are positioned, the cover portion 250 may separate the first dust-collection plate 210 and the second dust-collection plate 220 from an external space, thereby preventing the particles P from leaving, due to external factors such as wind W, the electric field formed by the first dust-collection plate 210 and the second dust-collection plate 220.

The cover portion 250 according to an embodiment of the present disclosure may be arranged apart from the caliper portion 100. Specifically, one end of the cover portion 250, which faces the caliper portion 100, and one end of the caliper portion 100, which faces the cover portion 250, may be spaced apart from each other by a preset interval.

Thus, as the brake disc BD may be exposed to the outside through a separation space between the caliper portion 100 and the cover portion 250, the brake disc BD may be exposed to the outside immediately after friction with the caliper portion 100 and be easily cooled.

A position of the cover portion 250 according to an embodiment of the present disclosure may be fixed. Specifically, the cover portion 250 may be fixedly connected to at least one of the brake disc BD, the caliper portion 100, the first dust-collection plate 210, or the second dust-collection plate 220.

Thus, the cover portion 250 may stably cover the first dust-collection plate 210 and the second dust-collection plate 220, thereby guiding the particles P flowing into the inside of the cover portion 250, to stably flow into the space between the first dust-collection plate 210 and the second dust-collection plate 220.

Referring to FIGS. 1 to 4, the guide portion 300 according to an embodiment of the present disclosure may provide a movement path for the particles P and selectively cover a space between the caliper portion 100 and the dust collection portion 200.

In the present specification, a ‘first position’ may be interpreted as a position of the guide portion 300 arranged to cover the caliper portion 100, and a ‘second position’ may be interpreted as a position of the guide portion 300 arranged spaced apart from the caliper portion 100.

However, the present disclosure is not limited thereto, and the ‘first position’ may be interpreted as a position of the guide portion 300 arranged to cover a preset area of the caliper portion 100, and the ‘second position’ may be interpreted as a position of the guide portion 300 arranged to cover a relatively narrower area than the above area of the caliper portion 100.

For example, when the guide portion 300 moves to the first position, the guide portion 300 may cover half or more of an outer circumferential surface of the caliper portion 100, and when the guide portion 300 moves to the second position, the guide portion 300 may cover half or less of the outer circumferential surface of the caliper portion 100.

Referring to FIGS. 2 to 4, the guide portion 300 may move in the circumferential direction of the brake disc BD.

In an embodiment, the guide portion 300 may receive an electrical signal from the control portion 500 and move in the circumferential direction of the brake disc BD.

Specifically, the guide portion 300 may receive power from the driving portion 400 and move in the circumferential direction of the brake disc BD, and the driving portion 400 may receive an electrical signal from the control portion 500 and adjust the position of the guide portion 300.

Referring to FIG. 3, the guide portion 300 may selectively accommodate the caliper portion 100 according to an electrical signal from the control portion 500.

A width of the guide portion 300 in the thickness direction of the brake disc BD may be relatively greater than a width of the caliper portion 100 in the thickness direction of the brake disc BD and a width of the dust collection portion 200 in the thickness direction of the brake disc BD.

The guide portion 300 may move in the circumferential direction of the brake disc BD, and as the guide portion 300 moves to the first position, the outer circumferential surface of the caliper portion 100 may be covered, and as the guide portion 300 moves to the second position, the outer circumferential surface of the caliper portion 100 may be exposed to the outside.

Referring to FIG. 3, the guide portion 300 may receive power from the driving portion 400 and move to the first position, thereby covering the outer circumferential surface of the caliper portion 100.

Accordingly, the guide portion 300 may partition the caliper portion 100 from the external space, thereby preventing the wind W toward the caliper portion 100 due to the driving of the vehicle, etc., from flowing into the inside of the caliper portion 100, and thereby guiding the movement path of the particles P generated inside the caliper portion 100, such that the particles P flow toward the dust collection portion 200 without being affected by the wind W, etc.

Referring to FIG. 4, the guide portion 300 may receive power from the driving portion 400 and move to the second position, thereby exposing the caliper portion 100 to the outside.

Accordingly, the wind W may flow into an internal space of the caliper portion 100 or the space between the caliper portion 100 and the dust collection portion 200, thereby improving a contact area between the wind W and the brake disc BD and thus increasing the cooling efficiency of the brake disc BD.

In an optional embodiment, a plurality of guide portions 300 may be provided, and the plurality of guide portions 300 may each receive power from the driving portion 400 and move independently in the circumferential direction of the brake disc BD.

In an embodiment, the position of the guide portion 300 may be adjusted according to the rotation speed of the brake disc BD, the temperature of the brake disc BD, the amount of the particles P generated, or the charge quantity of the particles P, and a detailed description thereof will be provided later.

The guide portion 300 may be movably connected to one side of the cover portion 250. Accordingly, the guide portion 300 may move relative to the cover portion 250 which is fixed to the brake disc BD, thereby selectively covering the caliper portion 100 or exposing the same to the outside.

As an optional embodiment, the guide portion 300 may be movably connected to one side of the caliper portion 100. Accordingly, the guide portion 300 may move relative to the caliper portion 100 fixed to the brake disc BD, thereby selectively covering the caliper portion 100 or exposing the same to the outside.

As an optional embodiment, the guide portion 300 may be movably connected to one side of the brake disc BD. Accordingly, the guide portion 300 may move relative to the brake disc BD, thereby selectively covering the caliper portion 100 fixed to the brake disc BD or exposing the same to the outside.

Referring to FIGS. 1 to 4, the guide portion 300 may be arranged to surround one end of the cover portion 250, which faces the caliper portion 100.

In detail, the guide portion 300 may be arranged to surround one end of the cover portion 250, which faces the caliper portion 100, and one end of the caliper portion 100, which faces the cover portion 250.

Accordingly, as the guide portion 300 covers a space between the one end of the cover portion 250 and the one end of the caliper portion 100, while the particles P generated in the caliper portion 100 move toward the cover portion 250, the particles P may be prevented from escaping to the outside from the space between the one end of the caliper portion 100 and the one end of the cover portion 250, thereby improving the performance of precipitating the particles P.

In an embodiment, a length of the guide portion 300 extending in the circumferential direction of the brake disc BD may be equal to or relatively greater than a distance between the one end of the cover portion 250 and the one end of the caliper portion 100.

In an embodiment, the length of the guide portion 300 extending in the circumferential direction of the brake disc BD may be relatively smaller than a length of the caliper portion 100 extending in the circumferential direction of the brake disc.

In an embodiment, the length of the guide portion 300 extending in the circumferential direction of the brake disc BD may be greater than half the length of the caliper portion 100 extending in the circumferential direction of the brake disc.

The guide portion 300 may be formed of a high heat conductivity material having high heat dissipation performance. Accordingly, even when the guide portion 300 is arranged at the first position to cover the caliper portion 100, heat generated in the caliper portion 100 may be allowed to be released to the outside, thereby guiding the movement path of the particles P and ensuring cooling efficiency of the brake disc BD.

Referring to FIG. 1, FIG. 2, and FIG. 6, the electrostatic precipitator 1 according to an embodiment of the present disclosure may include the control portion 500 configured to adjust the position of the guide portion 300.

Specifically, the control portion 500 may adjust the position of the guide portion 300 on the brake disc BD, and the control portion 500 may adjust the position of the guide portion 300 by controlling operation of the driving portion 400 that provides power to the guide portion 300.

The control portion 500 may obtain, from a sensor portion 600 to be described later, at least one of vehicle speed information, rotation speed information of the brake disc BD, temperature information of the brake disc BD, information about the amount of the particles P generated, or information about the charge quantity of the particles P, and may adjust the position of the guide portion 300 by using the obtained information.

Referring to FIG. 2, FIG. 3, and FIG. 6, the control portion 500 may control the operation of the driving portion 400 to arrange the guide portion 300 at the first position, such that the guide portion 300 covers the caliper portion 100.

When the vehicle speed is high or the brake disc BD rotates at high speed, the control portion 500 may control the operation of the driving portion 400 to arrange the guide portion 300 at the first position, such that the guide portion 300 covers the caliper portion 100.

Accordingly, the wind W may be restricted from flowing into the caliper portion 100, thereby preventing from escaping to the outside by the wind W without flowing toward the dust collection portion 200, and thus increasing the efficiency of precipitating the particles P.

When the amount of the particles P generated between the brake disc BD and the caliper portion 100 is large, the control portion 500 may control the operation of the driving portion 400 to arrange the guide portion 300 at the first position, such that the guide portion 300 covers the caliper portion 100.

When the charge quantity of the particles P is low, the control portion 500 may control the operation of the driving portion 400 to arrange the guide portion 300 at the first position, such that the guide portion 300 covers the caliper portion 100.

Accordingly, even when the charge quantity of the particles P is low, the guide portion 300 may guide a large amount of the particles P to flow toward the dust collection portion 200, thereby increasing the amount of the particles P captured in the dust collection portion 200.

Referring to FIG. 2, FIG. 4, and FIG. 6, the control portion 500 may control the operation of the driving portion 400 to arrange the guide portion 300 at the second position, such that the caliper portion 100 is exposed to the outside.

When the temperature of the brake disc BD rises to a preset temperature or higher, the control portion 500 may control the operation of the driving portion 400 to arrange the guide portion 300 at the second position, thereby exposing the caliper portion 100 to the outside.

Accordingly, the wind W may be allowed to flow into the caliper portion 100, and thus the caliper portion 100 or the brake disc BD may be effectively cooled by the wind W.

That is, the control portion 500 may obtain vehicle information from the sensor portion 600 and move the guide portion 300 to an appropriate position on the brake disc BD, thereby achieving the effect of adjusting the efficiency of precipitating the particles P and the cooling efficiency of the brake disc BD according to the driving conditions of the vehicle.

Referring to FIG. 6, the sensor portion 600 according to an embodiment of the present disclosure may obtain vehicle speed information, rotation speed information of the brake disc BD, temperature information of the brake disc BD, information about the amount of the particles P generated, or information about the charge quantity of the particles P, and transmit the information to the control portion 500.

Accordingly, the control portion 500 may appropriately adjust the position of the guide portion 300 according to vehicle operation information, external environment information, etc.

Hereinafter, an electrostatic precipitator 1′ according to another embodiment of the present disclosure will be described.

The electrostatic precipitator 1′ according to another embodiment of the present disclosure has the same configuration and operating principle as the electrostatic precipitator 1 according to an embodiment of the present disclosure, except that a cover portion 250′ of a dust collection portion 200′ is movable in the circumferential direction of the brake disc BD, and thus detailed description of the repeated details is omitted.

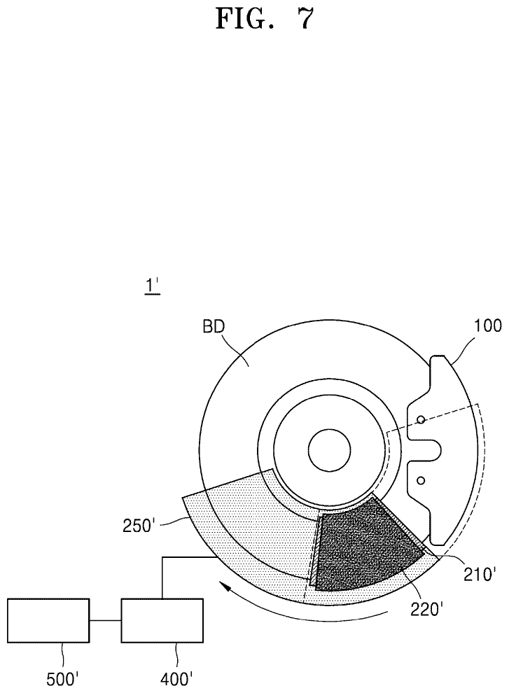

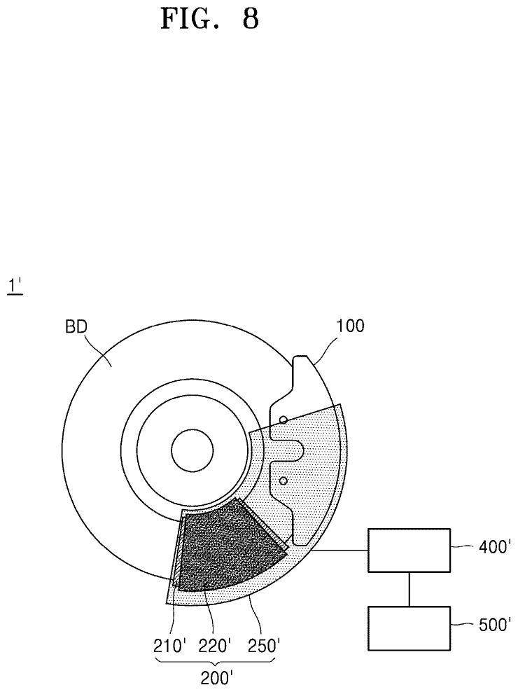

FIG. 7 is a diagram schematically illustrating a caliper-type electrostatic precipitator according to another embodiment of the present disclosure, and FIG. 8 is a diagram illustrating a state of use of a caliper-type electrostatic precipitator according to another embodiment of the present disclosure.

The dust collection portion 200′ of the electrostatic precipitator 1′ according to another embodiment of the present disclosure may include a first dust-collection plate 210′ to which a high voltage is applied, a second dust-collection plate 220′ that is spaced apart from the first dust-collection plate 210′ and grounded, and the cover portion 250′ that accommodates the first dust-collection plate 210′ and the second dust-collection plate 220′ thereinside and is movable in the circumferential direction of the brake disc BD.

Referring to FIG. 7 and FIG. 8, the cover portion 250′ may accommodate the first dust-collection plate 210′ and the second dust-collection plate 220′ thereinside, and may be formed to extend in the circumferential direction of the brake disc BD.

A length of the cover portion 250′ extending in the circumferential direction of the brake disc BD may be formed to be relatively longer than a length of each of the first dust-collection plate 210′ and the second dust-collection plate 220′ extending in the circumferential direction of the brake disc BD.

In addition, the length of the cover portion 250′ extending in the circumferential direction of the brake disc BD may be formed to be 60% to less than 100% of a sum of the lengths of the first dust-collection plate 210′ and the second dust-collection plate 220′ which extend in the circumferential direction of the brake disc BD and the length of the caliper portion 100 extending in the circumferential direction of the brake disc BD.

Accordingly, the cover portion 250′ may cover the first dust-collection plate 210′ and the second dust-collection plate 220′ while simultaneously covering one side of the caliper portion 100, and thus the cover portion 250′ may guide the particles P generated in the caliper portion 100, to flow to a space between the first dust-collection plate 210′ and the second dust-collection plate 220′.

Referring to FIG. 7 and FIG. 8, while moving toward the caliper portion 100, the cover portion 250′ may selectively cover the caliper portion 100.

In the present specification, a ‘third position’ may be interpreted as a position of the cover portion 250′ arranged to cover the caliper portion 100, and a ‘fourth position’ may be interpreted as a position of the cover portion 250′ arranged to expose the caliper portion 100 to the outside.

However, the present disclosure is not limited thereto, and the ‘third position’ may be interpreted as a position of the cover portion 250′ arranged to cover a preset area of the caliper portion 100, and the ‘fourth position’ may be interpreted as a position of the cover portion 250′ arranged to cover a relatively narrower area than the above area of the caliper portion 100.

For example, when the cover portion 250′ moves to the third position, the cover portion 250′ may cover half or more of the outer circumferential surface of the caliper portion 100, and when the cover portion 250′ moves to the fourth position, the cover portion 250′ may cover half or less of the outer circumferential surface of the caliper portion 100.

The cover portion 250′ may move in the circumferential direction of the brake disc BD.

The cover portion 250′ may receive an electrical signal from a control portion 500′ and move in the circumferential direction of the brake disc BD.

Specifically, the cover portion 250′ may receive power from a driving portion 400′ and move in the circumferential direction of the brake disc BD, and the driving portion 400′ may receive an electrical signal from the control portion 500′ and adjust the position of the cover portion 250′.

Referring to FIG. 8, the cover portion 250′ may selectively accommodate the caliper portion 100 according to the electrical signal from the control portion 500′.

A width of the cover portion 250′ in the thickness direction of the brake disc BD may be relatively greater than the width of the caliper portion 100 in the thickness direction of the brake disc BD.

The cover portion 250′ may move in the circumferential direction of the brake disc BD, and as the cover portion 250′ moves to the third position, the outer circumferential surface of the caliper portion 100 may be covered, and as the cover portion 250′ moves to the fourth position, the outer circumferential surface of the caliper portion 100 may be exposed to the outside.

Referring to FIG. 8, the cover portion 250′ may receive power from the driving portion 400′ and move to the third position, thereby covering the outer circumferential surface of the caliper portion 100.

Accordingly, the cover portion 250′ may partition the caliper portion 100 from the external space, thereby preventing the wind W toward the caliper portion 100 due to the driving of the vehicle, etc., from flowing into the inside of the caliper portion 100, and thereby guiding the movement path of the particles P generated inside the caliper portion 100, such that the particles P flow toward the dust collection portion 200′ without being affected by the wind W, etc.

Referring to FIG. 7, the cover portion 250′ may receive power from the driving portion 400′ and move to the fourth position, thereby exposing the caliper portion 100 to the outside.

Accordingly, the wind W may flow into the internal space of the caliper portion 100 or a space between the caliper portion 100 and the dust collection portion 200′, thereby improving the contact area between the wind W and the brake disc BD and thus increasing the cooling efficiency of the brake disc BD.

As an optional embodiment, a plurality of cover portions 250′ may be provided, and the plurality of cover portions 250′ may each receive power from the driving portion 400′ and move independently in the circumferential direction of the brake disc BD.

The position of the cover portion 250′ may be adjusted according to the rotation speed of the brake disc BD, the temperature of the brake disc BD, the amount of the particles P generated, or the charge quantity of the particles P, and a detailed description thereof will be provided later.

As an optional embodiment, the cover portion 250′ may be movably connected to one side of the caliper portion 100. Accordingly, the cover portion 250′ may move relative to the caliper portion 100 fixed to the brake disc BD, thereby selectively covering the caliper portion 100 or exposing the same to the outside.

As an optional embodiment, the cover portion 250′ may be movably connected to one side of the brake disc BD. Accordingly, the cover portion 250′ may move relative to the brake disc BD, thereby selectively covering the caliper portion 100 fixed to the brake disc BD or exposing the same to the outside.

The cover portion 250′ may be formed of a high heat conductivity material having high heat dissipation performance. Accordingly, even when the cover portion 250′ is arranged at the third position to cover the caliper portion 100, heat generated in the caliper portion 100 may be allowed to be released to the outside, so that the cover portion 250′ may guide the movement path of the particles P and also the cooling efficiency of the brake disc BD may be ensured at the same time.

The control portion 500′ may adjust the position of the cover portion 250′ on the brake disc BD, and the control portion 500′ may adjust the position of the cover portion 250′ by controlling the operation of the driving portion 400′ that provides power to the cover portion 250′.

The control portion 500′ may obtain, from the sensor portion 600 to be described later, at least one of vehicle speed information, rotation speed information of the brake disc BD, temperature information of the brake disc BD, information about the amount of the particles P generated, or information about the charge quantity of the particles P, and may adjust the position of the cover portion 250′ by using the obtained information.

Referring to FIG. 8, the control portion 500′ may control the operation of the driving portion 400′ to arrange the cover portion 250′ at the third position, such that the cover portion 250′ covers the caliper portion 100.

When the vehicle speed is high or the brake disc BD rotates at high speed, the control portion 500′ may control the operation of the driving portion 400′ to arrange the cover portion 250′ at the third position, such that the cover portion 250′ covers the caliper portion 100.

Accordingly, the wind W may be restricted from flowing into the caliper portion 100, thereby preventing from escaping to the outside by the wind W without flowing toward the dust collection portion 200′, and thus increasing the efficiency of precipitating the particles P.

When the amount of the particles P generated between the brake disc BD and the caliper portion 100 is large, the control portion 500′ may control the operation of the driving portion 400′ to arrange the cover portion 250′ at the third position, such that the cover portion 250′ covers the caliper portion 100.

When the charge quantity of the particles P is low, the control portion 500′ may control the operation of the driving portion 400′ to arrange the cover portion 250′ at the third position, such that the cover portion 250′ covers the caliper portion 100.

Accordingly, even when the charge quantity of the particles P is low, the cover portion 250′ may guide a large amount of the particles P to flow toward the dust collection portion 200, thereby increasing the amount of the particles P captured in the dust collection portion 200.

Referring to FIG. 7, the control portion 500′ may control the operation of the driving portion 400′ to arrange the cover portion 250′ at the fourth position, such that the caliper portion 100 is exposed to the outside.

When the temperature of the brake disc BD rises to a preset temperature or higher, the control portion 500′ may control the operation of the driving portion 400′ to arrange the cover portion 250′ at the fourth position, thereby exposing the caliper portion 100 to the outside.

Accordingly, the wind W may be allowed to flow into the caliper portion 100, and thus the caliper portion 100 or the brake disc BD may be effectively cooled by the wind W.

That is, the control portion 500′ may obtain vehicle information from the sensor portion 600 and move the cover portion 250′ to an appropriate position on the brake disc BD, thereby achieving the effect of adjusting the efficiency of precipitating the particles P and the cooling efficiency of the brake disc BD according to the driving conditions of the vehicle.

Each of the embodiments described above may be implemented independently, but the structure of each embodiment may be applied in combination with other embodiments.

Although the present disclosure has been described with reference to the embodiments shown in the drawings, these are merely examples, and those skilled in the art will understand that various modifications and equivalent other embodiments may be made therefrom. Therefore, the true technical protection scope of the present disclosure should be determined by the technical idea of the appended patent claims.

The specific implementations described in the embodiments are intended to be illustrative only and do not limit the scope of the embodiments in any way. Moreover, no item or component is essential to the practice of the present disclosure unless the element is specifically described as “essential” or “critical”.

The use of the terms “a” and “an” and “the” and similar referents in the context of describing the present disclosure (especially in the context of the following claims) are to be construed to cover both the singular and the plural. Furthermore, recitation of ranges of values in the embodiments are merely intended to serve as a shorthand method of referring individually to each separate value falling within the range, unless otherwise indicated herein, and each separate value is incorporated into the specification as if it were individually recited herein.

Finally, the steps of all methods according to the embodiments can be performed in any suitable order unless otherwise indicated herein or otherwise clearly contradicted by context. The embodiments are not limited to the order of describing the steps.

The use of any and all examples, or exemplary language provided herein, is intended merely to better illuminate the present disclosure and does not pose a limitation on the scope of the present disclosure unless otherwise claimed.

Numerous modifications, combinations, and adaptations according to design conditions and factors will be readily apparent to those skilled in this art without departing from the spirit and scope of the present disclosure.

### Industrial Applicability

According to an embodiment of the present disclosure, a caliper-type electrostatic precipitator and a vehicle braking device including the same are provided. In addition, the embodiments of the present disclosure may be applied to braking devices including an electrostatic precipitator for industrial use.

1. A caliper-type electrostatic precipitator comprising:
a caliper portion applying braking force to a brake disc;
a dust collection portion which is spaced apart from the caliper portion and electrostatically precipitates particles generated by friction between the brake disc and the caliper portion; and
a guide portion which is configured to cover a space between the caliper portion and the dust collection portion and provides a movement path of the particles.

2. The caliper-type electrostatic precipitator of claim 1, wherein
the guide portion is movable in a circumferential direction of the brake disc.

3. The caliper-type electrostatic precipitator of claim 2, further comprising
a control portion controlling a position of the guide portion in the circumferential direction of the brake disc.

4. The caliper-type electrostatic precipitator of claim 3, wherein the control portion is configured to adjust a position of the guide portion according to a rotation speed of the brake disc.

5. The caliper-type electrostatic precipitator of claim 2, wherein the guide portion is configured to selectively accommodate the caliper portion.

6. The caliper-type electrostatic precipitator of claim 2, wherein the dust collection portion comprises:
a first dust-collection plate to which a high voltage is applied;
a second dust-collection plate that is spaced apart from the first dust-collection plate and is grounded; and
a cover portion that accommodates the first dust-collection plate and the second dust-collection plate thereinside and extends in the circumferential direction of the brake disc,
wherein the guide portion is movably connected to one side of the cover portion.

7. The caliper-type electrostatic precipitator of claim 6, wherein the guide portion is arranged to surround one end of the cover portion, the one end facing the caliper portion.

8. A caliper-type electrostatic precipitator comprising:
a caliper portion applying braking force to a brake disc; and
a dust collection portion which is spaced apart from the caliper portion and electrostatically precipitates particles generated by friction between the brake disc and the caliper portion,
wherein the dust collection portion comprises:
a first dust-collection plate to which a high voltage is applied;
a second dust-collection plate that is spaced apart from the first dust-collection plate and is grounded; and
a cover portion that accommodates the first dust-collection plate and the second dust-collection plate thereinside and is movable in a circumferential direction of the brake disc.

9. The caliper-type electrostatic precipitator of claim 8, wherein the cover portion is configured to selectively cover the caliper portion while moving toward the caliper portion.

10. The caliper-type electrostatic precipitator of claim 8, further comprising a driving portion that receives power from the outside and provides driving force to the cover portion.

11. A vehicle braking device comprising:
a wheel of a vehicle;
a brake disc that rotates integrally with the wheel of the vehicle;
a caliper portion having a brake pad that applies braking force to the brake disc;
a dust collection portion disposed on the brake disc, spaced apart from the caliper portion, and electrostatically precipitating particles generated from the brake pad; and
a guide portion configured to move on the brake disc from an area where the caliper portion is located to an area where the dust collection portion is located.

12. The vehicle braking device of claim 11, wherein the guide portion is movable in a circumferential direction of the brake disc.

13. The vehicle braking device of claim 12, further comprising a control portion controlling a position of the guide portion in the circumferential direction of the brake disc.

14. The vehicle braking device of claim 13, wherein the control portion is configured to adjust a position of the guide portion according to a rotation speed of the brake disc.

15. The vehicle braking device of claim 12, wherein the dust collection portion comprises:
a first dust-collection plate to which a high voltage is applied;
a second dust-collection plate that is spaced apart from the first dust-collection plate and is grounded; and
a cover portion that accommodates the first dust-collection plate and the second dust-collection plate thereinside and extends in the circumferential direction of the brake disc,
wherein the guide portion is movably connected to one side of the cover portion.

16. The vehicle braking device of claim 15, wherein the guide portion arranged to surround one end of the cover portion, the one end facing the caliper portion.
